(19) United States
(12) Patent Application Publication
(10) Pub. No.: US 2010/0173741 A1
(43) Pub. Date: Jul. 8, 2010

(54) METHOD OF ALTERING A DRIVE RATIO ON A DRIVEN WHEEL AND A DRIVE ASSEMBLY IN ACCORDANCE WITH THE METHOD

(75) Inventor: Richard BAK, Ponoka (CA)

Correspondence Address: DAVIS & BUJOLD, P.L.L.C., 112 PLEASANT STREET, CONCORD, NH, 03301, US

(73) Assignee: Richard BAK, Ponoka (CA)

(21) Appl. No.: 12/432,149

(22) Filed: Apr. 29, 2009

(30) Foreign Application Priority Data
Jan. 7, 2009 (CA) 2649467

(51) Int. Cl. F16H 37/06

(52) U.S. Cl. 475/329

(57) ABSTRACT

A method of altering a drive ratio on a driven wheel includes providing a drive wheel, a driven wheel, and a planetary gear assembly having a sun gear, planetary gears, and a ring gear. Alternative inputs are provided to couple the drive wheel to the driven wheel in a first configuration and in a second configuration. At least one of the first configuration and the second configuration couples the drive wheel to the sun gear, planetary gears, and the ring gear as an input, and couples the driven wheel to another of the sun gear, planetary gears, and ring gear as an output.

### FIELD

A method of altering a drive ratio on a driven wheel and a wheel drive assembly in accordance with the method.

### BACKGROUND

The drive mechanism for motorcycles generally uses a means of driving the wheel through a system of a chain and two sprockets. The drive sprocket typically on the output shaft of the engine is the smaller of the two, and transmits the engine power through the chain to a much larger sprocket mounted to the rear wheel. This is called the “final drive”, and the difference in size between the two sprockets is called the “final drive ratio”. This ratio is chosen to give either a greater acceleration, or a greater top speed. Manufacturers generally find a compromise to give better all around performance.

In some circumstances, such as when stunting or in certain types of races, the top speed may be sacrificed for greater acceleration. This also makes “wheelies” easier, and provides a lower idling speed to make it easier to perform slow moving tricks without stalling the engine. However, this modification makes the motorcycle unsuitable for other uses, such as highway driving.

### SUMMARY

According to an aspect, there is provided a method of altering a drive ratio on a driven wheel. A drive wheel, a driven wheel, and a planetary gear assembly having a sun gear, planetary gears, and a ring gear are provided. Alternative inputs are provided to couple the drive wheel to the driven wheel in a first configuration and in a second configuration. At least one of the first configuration and the second configuration couples the drive wheel to the planetary gear assembly as an input, and couples the driven wheel to the planetary gear assembly as an output.

According to an aspect, there is provided a rear wheel drive assembly comprising a driven wheel, a drive wheel, and a planetary gear assembly having a sun gear, planetary gears, and a ring gear. A first input couples the drive wheel to the driven wheel in a first configuration. A second input couples the drive wheel to the driven wheel in a second configuration. At least one of the first configuration and the second configuration couples the drive wheel to the planetary gear assembly as an input, and couples the driven wheel to the planetary gear assembly as an output. There is a selection mechanism permitting selection of the first input or the second input depending upon a desired drive ratio.

### BRIEF DESCRIPTION OF THE DRAWINGS

These and other features will become more apparent from the following description in which reference is made to the appended drawings, the drawings are for the purpose of illustration only and are not intended to in any way limit the scope of the invention to the particular embodiment or embodiments shown, wherein:

FIG. 1 is a detailed perspective view of a prior art rear wheel drive assembly.

FIG. 2 is an exploded perspective view of the prior art rear wheel drive assembly of FIG. 1.

FIG. 3 is a side elevation view of a wheel drive assembly in a standard operating mode.

FIG. 4 is a front elevation view in section of the drive assembly of FIG. 3.

FIG. 5 is a side elevation view of the wheel drive assembly of FIG. 3 in a reduction operating mode.

FIG. 6 is a front elevation view in section of the drive assembly of FIG. 5.

FIG. 7 is an exploded perspective view of the wheel drive assembly of FIG. 3.

FIG. 8 is a schematic of a planetary gear assembly.

### DETAILED DESCRIPTION

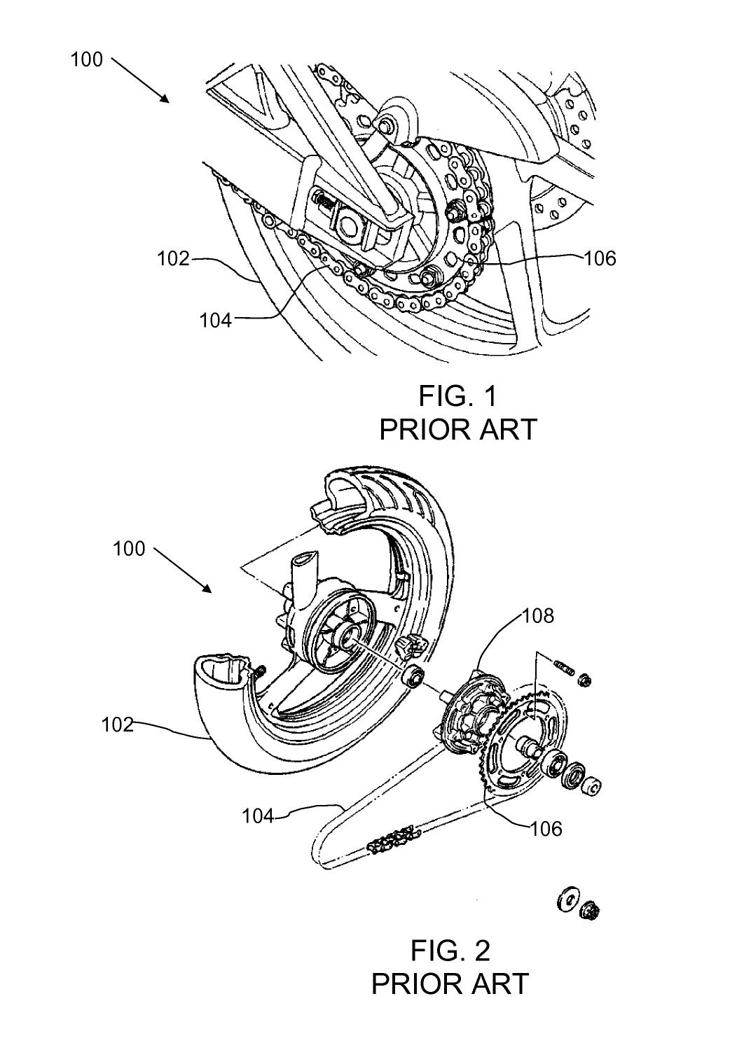

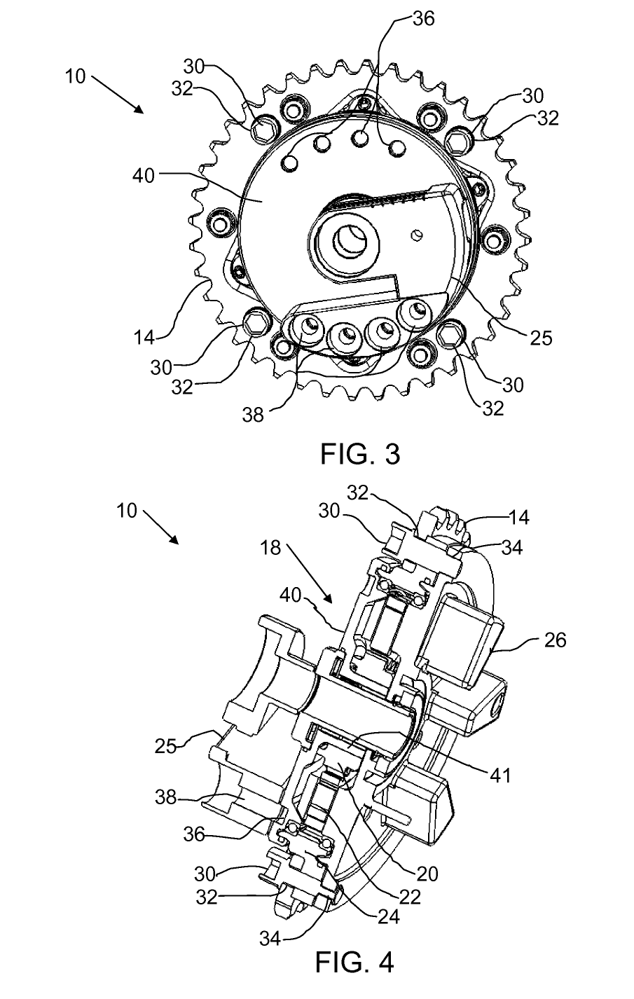

An example of a prior art rear wheel drive assembly, generally identified by reference numeral 100, will first be discussed with reference to FIGS. 1 and 2. The present rear wheel drive assembly, generally identified by reference numeral 10, will then be described with reference to FIG. 3 through 8.

Prior Art Wheel Drive Assembly 100

Referring to FIG. 1, the driven or rear wheel 102 of, for example, a motorcycle or ATV is driven by a chain 104 that is connected to the motor and the transmission of the vehicle (not shown). Referring to FIG. 2, chain 104 engages a chain sprocket 106, which drives the rear wheel 102 via a rear sheave 108. This example uses a typical “cush drive” that is used on motorcycles with a high torque to reduce the damage.

Structure and Relationship of Parts:

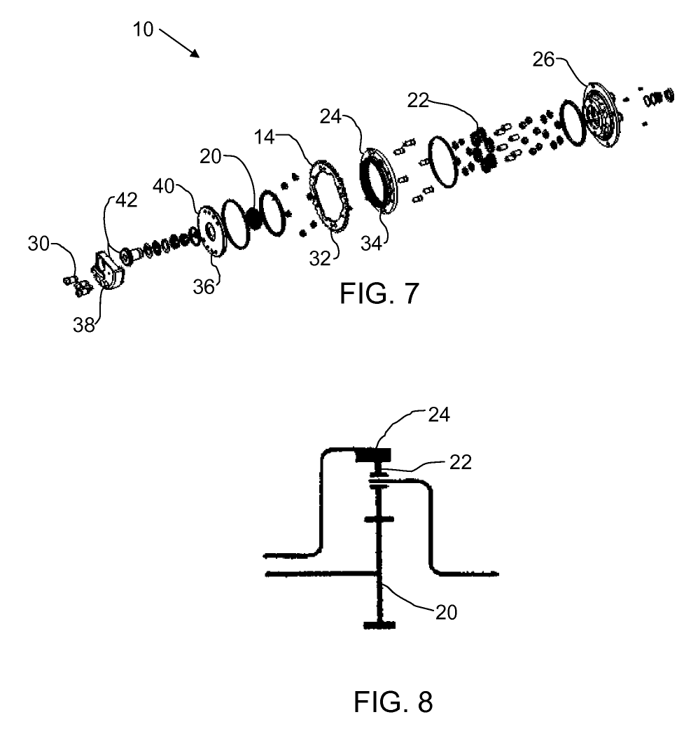

Rear wheel drive assembly 10 is installed on a motorcycle or ATV, an example of which is shown in FIGS. 1 and 2, with wheel 102. Referring to FIG. 3, there is a drive wheel 14, such as a chain sprocket as shown that receives power from the motor and the transmission of the vehicle (not shown) via a chain 104 (shown in FIG. 1). It will be understood that assembly 10 is intended to be installed in a location similar to chain sprocket 106 and coupling 108 shown in FIGS. 1 and 2, and is intended to perform the same function, namely, to drive the driven wheel 102. Referring to FIG. 7, a planetary gear assembly generally indicated by reference numeral 18 is provided that has a sun gear 20, planetary gears 22, and a ring gear 24.

Assembly 10 is designed to permit drive wheel 14 to be coupled to driven wheel 102 in different configurations to provide different gear ratios. To allow these different gear ratios, at least one of the configurations couples drive wheel 14 to one of sun gear 20, planetary gears 22, and ring gear 24 of planetary gear assembly 18 as the input, and couples driven wheel 102 to another of sun gear 20, planetary gears 22, and ring gear 24 of planetary gear assembly 18 as an output. In a preferred embodiment, ring gear 24 is coupled to drive wheel 14 and planetary gears 22 are secured to driven wheel 102 either directly or indirectly, such that they drive driven wheel 102, and is positioned mechanically between wheel 102 and drive wheel 14. Drive assembly 10 is supported by the axle of the motorcycle, and the axle is supported by swing arm bracket 25, which attaches to the swing arm of the motorcycle. As depicted, planetary gears 20 are secured to driven wheel 102 via wheel coupling 26, also referred to as a sheave. While chains and sprockets as depicted in the embodiment described herein, it will be understood that these teachings may equally be applied to other common drive systems such as belts and pulleys, and shafts and differentials.

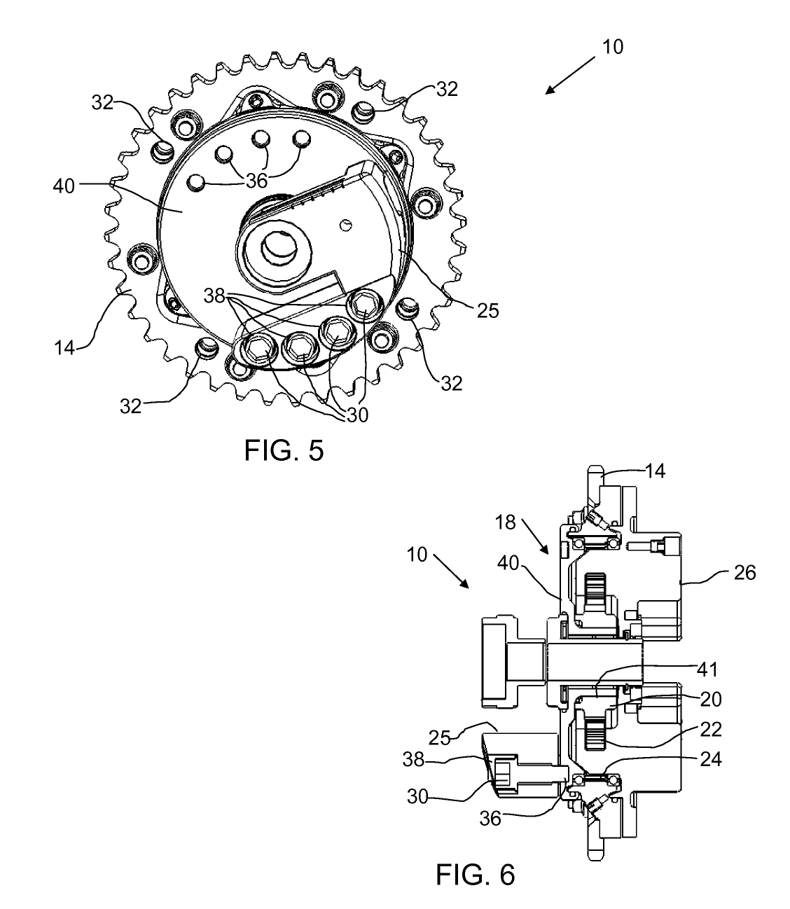

Referring to FIG. 3, drive wheel 14 is directly connected to ring gear 24. The first input couples drive wheel 14 and ring gear 24 to wheel coupling 26 to achieve a 1:1 drive ratio. Referring to FIG. 4, as depicted, this is in the form of a pin connection using bolts 30 that are inserted through an outer set of pin receptacles 32 in drive wheel 14 that engage a corresponding set of pin receptacles 34 in wheel coupling 26, which effectively immobilizes planetary gears 22 and sun gear 20 relative to ring gear 24. Thus, in this configuration, drive wheel 14, ring gear 24, planetary gears 22 and sun gear 20 are all stationary relative to each other, such that wheel 102 is driven in a 1:1 ratio with driven wheel 14. Referring to FIG. 5, a second input couples sun gear 20 to the vehicle to hold them stationary relative to each other, with bolts 30 removed from outer pin receptacles 32. The rotation of drive wheel 14 and ring gear 24 causes planetary gears 22 to rotate and revolve around sun gear 20, which is stationary. As mentioned above, planetary gears 22 are coupled to wheel coupling 26, such that a gear reduction occurs between drive wheel 14 and wheel coupling 26, and thus driven wheel 102. The desired gear reduction is defined by the relative sizes of the various gears in planetary gear assembly 18.

Referring to FIG. 6, as depicted, sun gear 20 includes a center portion 40 that extends outward. Center portion 40 is in the form of a disc that is secured to sun gear 20 via splines 41. Bolts 30 are inserted through pin receptacles 38 in swing arm bracket 25 and are secured to sun gear 20 via pin receptacles 36 in center portion 40. This arrangement was selected to conserve space and make the connections easily accessible. It will be understood that other designs that permit sun gear 20 to be held stationary such that planetary gears 22 revolve around it are also possible.

It will be understood that, while direct connections are depicted and discussed, connections through intermediate components or using a selection mechanism other than the pin connections depicted may be used in order to permit the selection of the first input or the second input, depending upon a desired drive ratio. In the depicted embodiment, the selection mechanism is the pins or bolts 30 that are extended either through inner set of pin receptacles 38 into pin receptacles 36 of sun gear 20 or through outer set of pin receptacles 32 into pin receptacles 34 of wheel coupling 26.

Operation:

Referring to FIG. 7, an embodiment of drive assembly 10 is assembled using the parts shown, and as described above. Drive assembly 10 is then installed on a vehicle, such as the rear wheel of a motorcycle, where chain sprocket 106 and coupling 108 would normally be located as shown in FIGS. 1 and 2. This may be a retrofit, or it may be done at the point of manufacture. Drive wheel 14 is assembled with ring gear 24 attached to it. Once installed, bolts 30 are inserted in selected receptacles, depending on the drive mode that is desired. To obtain the normal driving mode, referring to FIGS. 3 and 4, bolts 30 are inserted through outer receptacles 32 in drive wheel 14 and into receptacles 34 in wheel coupling 26. This causes driven wheel 102 of the vehicle to be driven using a 1:1 ratio. In this configuration, planetary gears 22 and sun gear 20, which are connected to wheel coupling 26, also rotate with drive wheel 14.

Referring to FIGS. 5 and 6, to switch to the reduction mode, bolts 30 are removed from receptacles 32 and 34, and inserted into receptacles 38 and 36 to release drive wheel 14 from wheel coupling 26, and to secure swingarm bracket 25 to sun gear 20, such that it remains stationary. As ring gear 24 rotates, planetary gears 22 revolve around sun gear 20, which introduces a gear reduction between drive wheel 14 and wheel coupling 26. While drive wheel 14 still drives the driven wheel 102, it is reduced by the gear ratio of planetary gear assembly 18 to achieve a higher acceleration, lower idling speed, by reducing the top speed. The mode may be switched back to the regular mode by again moving bolts 30 to the desired position.

Variations:

In the embodiment given above, both drive wheel 14 and wheel coupling 26 are coupled to achieve a 1:1 drive ratio. In the other configuration, drive wheel 14 is decoupled from wheel coupling 26 and sun gear 20 is held stationary to achieve a different drive ratio. In both configurations, ring gear 24 is always coupled to drive wheel 14, and wheel coupling 26 is always connected to planetary gears 22. However, it will be understood that the use of planetary gear assembly 18 allows other inputs and outputs to be used. Referring to FIG. 8, drive wheel 14 and wheel coupling 26 may be coupled to any of sun gear 20, planetary gears 22, and ring gear 24, depending on the preferences of the user and the application. With planetary gears generally, one gear is held stationary, another gear receives the input, and the remaining gear acts as the output. Based on these principles, it may also be possible to have two configurations that give gear ratios that are not 1:1, or to provide more than two configurations with more than two gear ratios.

These variations may require adjustments in the location of the various components from what is depicted; however these changes are within the ability of those of ordinary skill.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiments without departing from scope of the Claims.

What is claimed is:

1. A method of altering a drive ratio on a driven wheel, comprising:
providing a drive wheel that is driven by a vehicle transmission, a driven wheel, and a planetary gear assembly having a sun gear, planetary gears, and a ring gear;
providing alternative inputs to couple the drive wheel to the driven wheel in a first configuration and in a second configuration, wherein at least one of the first configuration and the second configuration couples the drive wheel to one of the sun gear, planetary gears, and the ring gear as an input, and couples the driven wheel to another of the sun gear, planetary gears, and the ring gear as an output.

2. The method of claim 1, wherein a first of the alternative inputs couples the drive wheel to the driven wheel through the planetary gear assembly in a first configuration, and a second of the alternative inputs coupling the drive wheel to the driven wheel through the planetary gear assembly in a second configuration, the first alternative input or the second alternative input being selected depending upon a desired drive ratio.

3. The method of claim 1, wherein the drive wheel is one of a chain sprocket, a belt driven pulley and a differential gear.

4. The method of claim 1, wherein the first configuration secures the movement of the driven wheel to the movement of the drive wheel, and the second configuration secures the drive wheel to the ring gear, the driven wheel to the planetary gears, and the sun gear to a non-rotating object, such that the planetary gears revolve around the sun gear and the ring gear revolves around the planetary gears.

5. A drive assembly, comprising:
a driven wheel;
a drive wheel driven by a vehicle transmission;
a planetary gear assembly having a sun gear, planetary gears, and a ring gear;
a first input coupling the drive wheel to the driven wheel in a first configuration;
a second input coupling the drive wheel to the driven wheel in a second configuration, at least one of the first configuration and the second configuration coupling the drive wheel to one of the sun gear, planetary gears, and the ring gear as an input, and coupling the driven wheel to another of the sun gear, planetary gears, and the ring gear as an output; and
a selection mechanism permitting selection of the first input or the second input depending upon a desired drive ratio.

6. The drive assembly of claim 5, wherein the drive wheel is one of a chain sprocket, a belt driven pulley and a differential gear.

7. The drive assembly of claim 5, wherein the driven wheel is a rear wheel of a motorcycle.

8. The drive assembly of claim 5, wherein the first configuration secures the movement of the driven wheel to the movement of the drive wheel, and the second configuration secures the drive wheel to the ring gear, the driven wheel to the planetary gears, and the sun gear to a non-rotating object, such that the planetary gears revolve around the sun gear.

9. The drive assembly of claim 5, wherein each of the drive wheel, the driven wheel, the non-rotating body, and the sun gear has a set of pin receptacles, the selection mechanism being pins that connect either the drive wheel set of pin receptacles and the driven wheel set of pin receptacles, or the stationary body set of pin receptacles and the sun gear set of pin receptacles.

10. A drive assembly, comprising
a driven wheel;
a drive wheel driven by a vehicle transmission;
a planetary gear assembly having a sun gear, planetary gears, and a ring gear, the ring gear being secured to the drive wheel, and the planetary gears being secured to the driven wheel;
a first input immobilizes the planetary gears relative to the ring gear, coupling the driven wheel to the drive wheel;
a second input coupling the sun gear to a non-rotating body such that the planetary gears revolve around the sun gear, and coupling the driven wheel to the drive wheel through the planetary gear assembly; and
a selection mechanism permitting selection of the first input or the second input depending upon a desired drive ratio.
